(19) United States
(12) Patent Application Publication
(10) Pub. No.: US 2010/0000418 A1
(43) Pub. Date: Jan. 7, 2010

(54) COOKING APPLIANCE COMPRISING A LID WITH VIEWING WINDOW

(75) Inventors: Jean-Marc Payen, Quetigny (FR); Olivier Pellerin, Minot (FR); Frédéric Seurat, Bretigny (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 12/496,055

(22) Filed: Jul. 1, 2009

(30) Foreign Application Priority Data
Jul. 2, 2008 (FR) 08 03748

(51) Int. Cl. A47J 37/12; A47J 36/06; A47J 36/38

(52) U.S. Cl. 99/341; 99/403

(57) ABSTRACT

A cooking appliance, particularly an electric fryer, having a vat and a lid enclosing a cooking chamber, the lid having a viewing window disposed at least partly above the vat. The cooking chamber has an air inlet and an air and a cooking vapor outlet connected to a suction device. Air introduced through the air inlet is directed toward the air and cooking vapor outlet, while passing under the viewing window. According to the invention, the air and cooking vapor outlet has a plurality of perforations forming conduits extending away from the viewing window.

### BACKGROUND OF THE INVENTION

The present invention relates to the technical field of cooking appliances comprising a vat provided for containing a cooking bath and a lid having a viewing window. The present invention relates particularly, though not exclusively, to electric fryers.

The patent document EP 1 224 896 discloses a cooking appliance comprising a lid equipped with a viewing window and a device for filtering cooking vapors.

In devices of the aforementioned type, the viewing window has a small size that limits observation of the contents of the vat. Furthermore, the large quantity of cooking vapors emitted when foods are immersed into a frying bath makes the view seen through the viewing window less than satisfactory. Moreover, cooking vapor filtering performance is generally limited.

Increasing the size of the viewing window promotes the appearance of condensates on the inside wall of the lid. Condensates falling back into the cooking vat can create explosions in a fat-based cooking bath, particularly when the size of the drops falling into the cooking bath becomes significant.

The patent document EP 150 516 discloses a cooking appliance comprising a cooking chamber having an air inlet and an air and cooking vapor outlet connected to a suction and filtering device. The cooking chamber comprises a vat and a lid, the lid having a viewing window. An opening is provided for the passage of the handle of a cooking basket disposed in the vat. The suction makes it possible to prevent the formation of steam on the viewing window when the lid is in place on the vat. However, the viewing window is raised relative to the rest of the lid.

The viewing window can have a first, front, opening offset relative to the air and cooking vapor outlet of the suction device, and a second, rear, opening disposed opposite the first, front, opening and also offset relative to the air and cooking vapor outlet. The width of the first, front, opening and the width of the second, rear, opening are not specified. The second, rear, opening limits the flow of air passing under the viewing window. The viewing window disclosed in this document is limited in size. No precise indication is given on the effectiveness of the proposed structure in preventing condensates from falling back into the vat.

The patent document WO 93/10698 discloses a cooking appliance with forced ventilation comprising a vat and a lid, wherein the air inlet and the air and cooking vapor outlet are sized and positioned so as to create, in conjunction with a minimum suction rate, an air stream for scavenging the cooking chamber. However, this document does not disclose an appliance with a lid comprising a viewing window.

### BRIEF SUMMARY OF THE INVENTION

The present invention provides a cooking appliance comprising a vat provided for containing a cooking bath and a lid having a viewing window, wherein the observation of the contents of the vat is improved. As used herein the term “vat” identifies a part that, in a deep fryer, is also termed a bowl, or a tank.

The present invention also provides a cooking appliance comprising a vat provided for containing a cooking bath and a lid having a viewing window, wherein the fall of condensates into the vat can be limited during cooking.

The present invention also provides a cooking appliance comprising a vat provided for containing a cooking bath and a lid having a viewing window, wherein the temperature of the lid can be limited during cooking.

The present invention also provides a cooking appliance comprising a vat provided for containing a cooking bath and a lid having a viewing window, wherein an effective filtering of the cooking vapors can be obtained.

For these purposes, the present invention is embodied in a cooking appliance, particularly an electric fryer, comprising a vat and a lid defining a cooking chamber, and a suction device, wherein: the lid has a viewing window disposed at least partly above the vat; the cooking chamber has an air inlet and an air and cooking vapor outlet connected to the suction device; and the air and cooking vapor outlet comprises a plurality of perforations forming conduits extending away from the viewing window for causing air introduced through the air inlet to be directed toward the air and cooking vapor outlet and to pass under the viewing window.

These arrangements make it possible to facilitate the drawing of the cooking vapors toward the air and cooking vapor outlet, while limiting cooking vapor contact with the viewing window. The arrangement of the perforations makes it possible to improve the scavenging of the lower surface of the viewing window. The flow of air passing under the viewing window makes it possible to perform a scavenging of the cooking vapors and deflection of the cooking vapors from the viewing window. This scavenging that takes place underneath the viewing window makes it possible to prevent or strongly limit the deposit of greasy vapors on the lower surface of the viewing window, thus improving visibility through said viewing window. This scavenging that takes place underneath the viewing window also makes it possible to limit the formation of droplets of condensates on the lower surface of the viewing window. This scavenging also makes it possible to dilute the cooking vapors in the cooler aspirated air. The temperature of the gaseous exhaust emitted from the suction device and the temperature of the lid are therefore lowered.

Advantageously, the air inlet is disposed opposite the air and cooking vapor outlet. This arrangement makes it possible to limit head losses and improve the effectiveness of the suction.

In an advantageous embodiment, the air introduced through the air inlet is channeled under the viewing window toward the air and cooking vapor outlet through the top part of the cooking chamber disposed above the vat. By channeling the air sucked into the cooking chamber it becomes possible to limit, or even prevent, turbulence in the top part of the cooking chamber, thus improving the evacuation of cooking vapors out of the cooking chamber.

Advantageously, for better efficiency, the air introduced into the cooking chamber through the air inlet and sucked out through the air and cooking vapor outlet scavenges at least 80% of the width of the surface of the viewing window disposed above the vat.

Also advantageously, the surface area of the viewing window is greater than or equal to 50% of the surface area of the vat. With the help of the suction device, the large surface area of the viewing window allows easy observation of the contents of the vat during cooking without promoting the formation of condensates that are likely to fall back into the cooking vat.

Also advantageously, the lower surface of the viewing window has a profile that rises between the air inlet and the air and cooking vapor outlet. This arrangement makes it possible to facilitate the suction of air and cooking vapors.

Advantageously, the viewing window is made of glass. Although glass is more prone to the formation of condensates than high temperature- and hydrolysis-resistant transparent plastics such as for example polysulfones, the proposed suction device makes it possible to prevent the formation of condensates.

Also advantageously, the air inlet and the air and cooking vapor outlet extend across at least 80% of the width of the viewing window disposed above the vat. This arrangement enables better scavenging of the lower surface of the viewing window.

Advantageously, the air inlet extends over at least 80% of the width of the vat. This arrangement enables better scavenging of the surface of the vat, resulting in a better extraction of the cooking vapors.

Also advantageously, the air and cooking vapor outlet extends over at least 80% of the width of the vat. This arrangement enables better suction of the cooking vapors and of the air introduced into the cooking chamber.

Also advantageously, the air inlet and the air and cooking vapor outlet are disposed opposite each other with respect to the vat. This arrangement enables better scavenging of the surface of the vat, resulting in a better extraction of the cooking vapors.

Also advantageously, the distance between the air inlet and the air and cooking vapor outlet is greater than the width of the air inlet. This arrangement makes it possible to obtain more even suction and a better evacuation of the cooking vapor-laden air.

Also advantageously, the distance between the air inlet and the air and cooking vapor outlet is greater than the width of the air and cooking vapor outlet. This arrangement makes it possible to limit head losses and obtain more effective suction for a given surface area of the vat.

In an advantageous embodiment, the vat is disposed inside an outer housing. This arrangement makes it possible to lower the temperature of the lateral walls of the appliance.

Advantageously, the vat is mounted to be removable from the outer housing. This arrangement makes it possible to facilitate cleaning of the appliance.

Advantageously, the air inlet is disposed between the outer housing and the lid. This arrangement makes it possible to simplify the structure of the appliance.

Also advantageously, the suction device is removable from the vat. This arrangement makes it possible to facilitate cleaning of the appliance.

Advantageously, the suction device is supported by a control box. If desired, the control box can support a heating resistor provided so as to be placed in the vat.

Advantageously, the suction device is housed inside the control box. This arrangement makes it possible to simplify the use of the device.

Also advantageously, the suction device is associated with a filtering device. This arrangement makes it possible to improve the performance of the device.

Advantageously, the filtering device comprises a filter unit that is removable from the suction device. This arrangement makes it possible to simplify the use of the device.

Also advantageously, the suction device has a cooking vapor vent disposed laterally relative to the control box. This arrangement makes it possible to reduce the size of the control box and avoid the user's being disturbed by the cooking vapors emerging from the appliance while using the control box, for example to adjust the cooking temperature and/or a cooking time.

Statements herein that one part is removable from another should be understood to mean that there are no fastening elements that must be removed or loosened before removal can take place.

### BRIEF DESCRIPTION OF THE DRAWINGS

The invention will be better understood from the description of a nonlimiting exemplary embodiment, illustrated in the attached FIGS. 1 through 12, in which:

FIG. 1 is an exploded perspective view of an exemplary cooking appliance according to the invention;

FIG. 2 is an assembled perspective view of the appliance illustrated in FIG. 1;

FIG. 3 is a perspective view of the appliance illustrated in FIG. 2, in which the lid and a filter unit have been removed;

FIG. 4 is a front perspective view of an embodiment of the filter unit of the appliance illustrated in FIGS. 1 and 2,

FIG. 5 is an exploded rear perspective view of the filter unit illustrated in FIG. 4;

FIG. 6 is a longitudinal cross-sectional side view of the appliance illustrated in FIGS. 1 and 2;

FIG. 7 is a partial cut-away longitudinal and cross-sectional perspective view of the appliance illustrated in FIGS. 1 and 2;

FIG. 8 is a cross-sectional view from the rear at the level of the vat of the appliance illustrated in FIGS. 1 and 2, taken along line 8-8 of FIG. 6;

FIG. 9 is a cross-sectional view from the front at the level of the vat of the appliance illustrated in FIGS. 1 and 2, taken along line 9-9 of FIG. 6;

FIG. 10 is a front cross-sectional view at the level of the ventilation device of the appliance illustrated in FIGS. 1 and 2;

FIG. 11 is a perspective detail view of a portion of the appliance illustrated in FIGS. 1 and 2 showing a safety device associated with the filter unit;

FIG. 12 is a side detail view of a portion of the appliance illustrated in FIGS. 1 and 2.

### DETAILED DESCRIPTION OF THE INVENTION

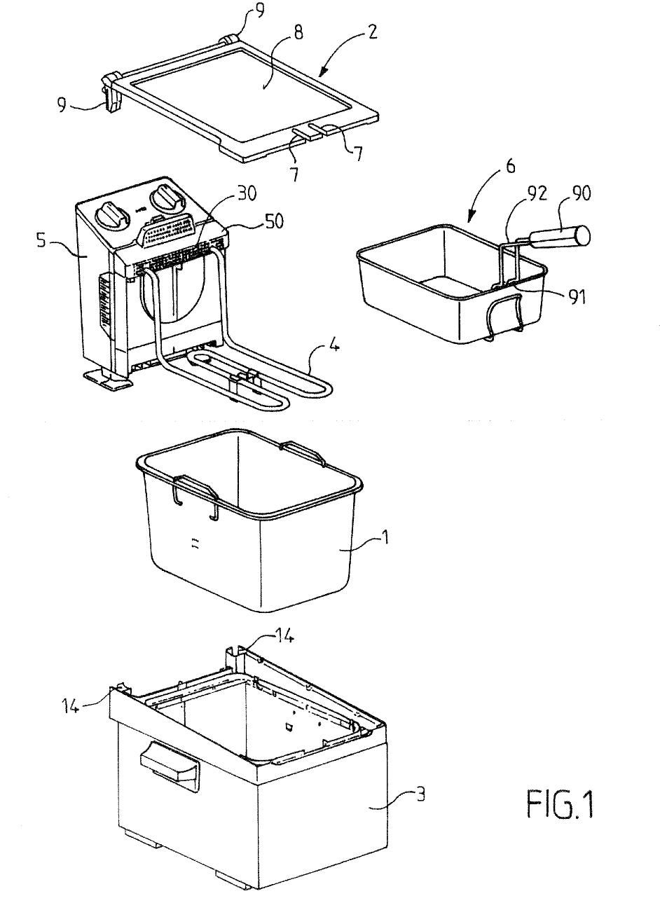

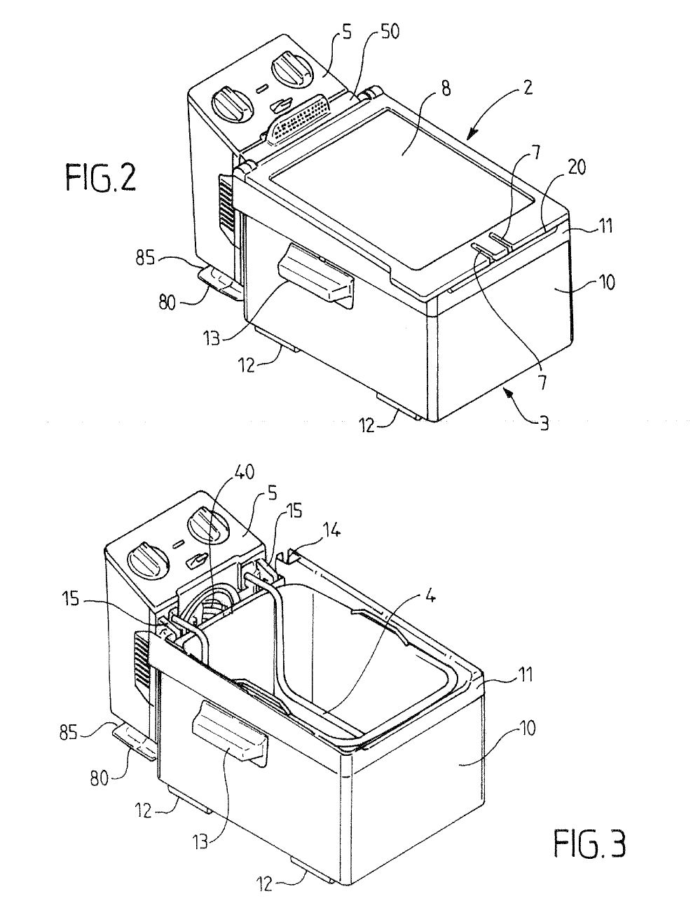

FIGS. 1 and 2 illustrate a cooking appliance, particularly an electric fryer, comprising a vat 1 and a lid 2 delimiting a cooking chamber. Vat 1 is disposed inside an outer housing 3 and is removably mounted relative to outer housing 3.

The appliance further comprises an electric heating resistor 4 connected to a control box 5 separate, and removable, from vat 1.

Vat 1 is provided for receiving a cooking bath. A basket 6 is provided so as to be placed inside vat 1 and receive food. Basket 6 can, for example, have lateral walls and/or a bottom made of openwork and/or wire mesh. Basket 6 has a handle 90.

Lid 2 has notches 7 provided for the passage of handle 90. Handle 90 has a lower support zone 91 provided for holding the basket in a raised position inside vat 1. Handle 90 has an upper support zone 92 provided for holding basket 6 in a lowered position inside vat 1.

Lid 2 includes a viewing window 8. The surface area of viewing window 8 is greater than or equal to 50% of the surface area of vat 1. Advantageously, viewing window 8 is made of glass.

Outer housing 3 has a bottom part 10, for example made of sheet metal, and a top part 11, advantageously made of plastic. Bottom part 10 is equipped with support elements 12. A handle 13 is disposed on each of the lateral surfaces of bottom part 10. Top part 11 is provided for supporting vat 1. Lid 2 comprises pivot pins 9 provided so as to be inserted into receptacles 14 of outer housing 3. Thus, lid 2 is pivotably mounted on outer housing 3. Lid 2 is removably mounted on outer housing 3.

As seen in FIG. 3, electric heating resistor 4 is disposed inside vat 1. Control box 5 is assembled with outer housing 3, for example by means of slide rails, not shown in the figures. Advantageously, outer housing 3 supports control box 5.

The heating chamber has an air inlet 20, more visible in FIG. 2, and an air and cooking vapor outlet 30, more visible in FIG. 1, connected to a suction device 40, more visible in FIG. 3. Air inlet 20 and air and cooking vapor outlet 30 are disposed at respective opposite edges of housing 3 so as to limit head, or pressure, losses. This arrangement facilitates attainment of a laminar air flow that enters through air inlet 20 when cooking vapor emissions are low. This arrangement enables better evacuation of air and cooking vapors when cooking vapor emissions are higher, for example when basket 6 containing the food to be fried is immersed into vat 1 containing a cooking bath. Lid 2 has a lower wall that inclines upward between air inlet 20 and air and cooking vapor outlet 30. As shown in FIG. 2, air inlet 20 is disposed between outer housing 3 and lid 2.

More particularly, suction device 40 is supported by control box 5. Thus, suction device 40 is removable relative to vat 1.

Suction device 40 is associated with a filtering device 50, illustrated in FIGS. 1 and 2. Filtering device 50 is advantageously at least partly disposed upstream from suction device 40. More particularly, filtering device 50 is supported by control box 5. Filtering device 50 comprises a filter unit 51 that is removable relative to suction device 40.

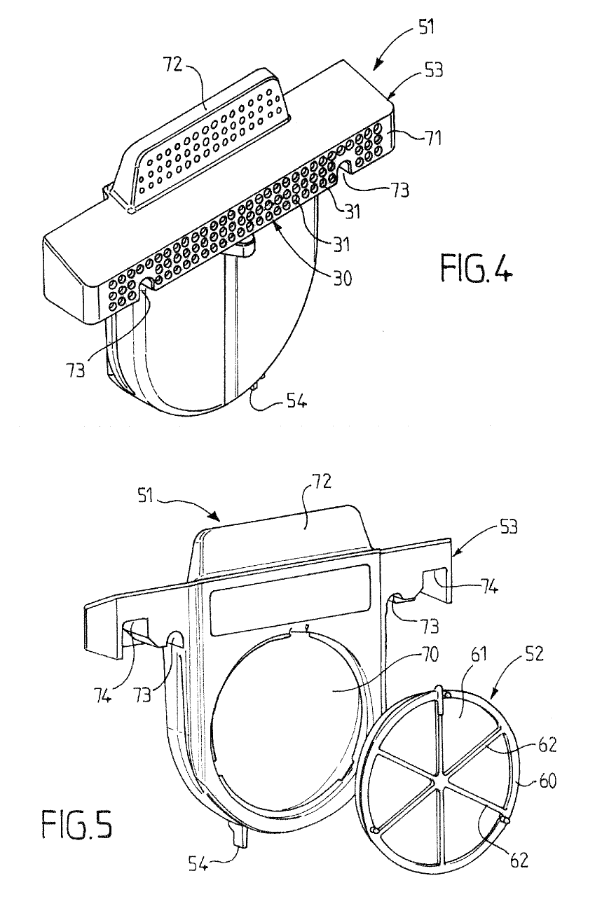

As seen more clearly in FIGS. 4 and 5, filter unit 51 comprises a filter cartridge 52 removably mounted in a cartridge holder 53. Filter cartridge 52 comprises a frame 60 surrounding a filtering surface 61. Arms 62 originating at frame 60 divide filtering surface 61 into segments. Filtering surface 61 advantageously includes one or more active carbon filters. Filter cartridge 52 is mounted in an opening 70 of cartridge holder 53, for example by means of a bayonet coupling.

As clearly seen in FIGS. 1, 4, 6, 7 and 9, air and cooking vapor outlet 30 has a plurality of perforations 31 forming conduits extending away from viewing window 8. Thus, air sucked out by suction device 40 tends to scavenge the lower surface of viewing window 8.

Air and cooking vapor outlet 30 is disposed on cartridge holder 53 and is advantageously in the form of a plurality of perforations 31 formed in a front wall 71 of cartridge holder 53. Cartridge holder 53 forms a hollow body which conducts the air and the cooking vapors from air and cooking vapor outlet 30 to filter cartridge 52. Cartridge holder 53 has a grasping element 72, lower notches 73 provided for passage of electric heating resistor 4, and support zones 74 provided for resting on control box 5, more particularly on vertical members 15 visible in FIG. 3.

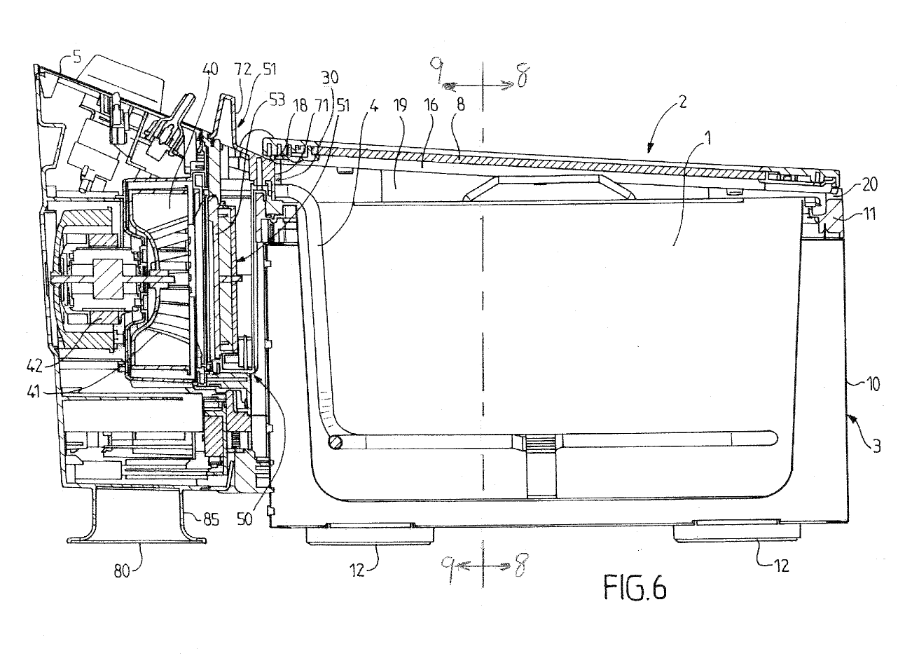

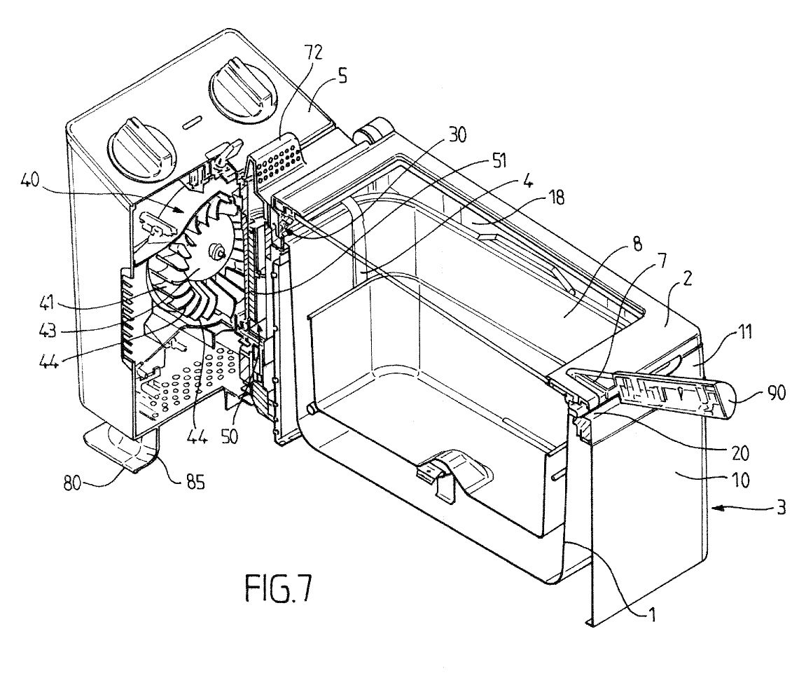

As seen more clearly in FIGS. 6 and 7, viewing window 8 is disposed at least partly above vat 1. The lower surface of viewing window 8 has a profile that rises between air inlet 20 and air and cooking vapor outlet 30. Suction device 40 is housed inside control box 5 and comprises a ventilation unit 41 driven by a motor 42. Ventilation unit 41 is disposed laterally relative to vat 1 and has a suction zone 43 disposed facing filtering surface 61 of filter unit 51. Suction zone 43 is surrounded by blades 44. Thus, ventilation unit 41 forms an exhaust turbine. As seen more clearly in FIG. 3, ventilation unit 41 is accessible when filter unit 51 is removed from the device. Air inlet 20 and air and cooking vapor outlet 30 are disposed opposite each other with respect to vat 1.

Vat 1 can be defined by a longitudinal dimension extending between air inlet 20 and air and cooking vapor outlet 30 and by a first transverse dimension alongside air inlet 20 and a second transverse dimension alongside air and cooking vapor outlet 30. Viewing window 8 can also be defined by a longitudinal dimension extending between air inlet 20 and air and cooking vapor outlet 30 and by a first transverse dimension alongside air inlet 20 and a second transverse dimension alongside air and cooking vapor outlet 30.

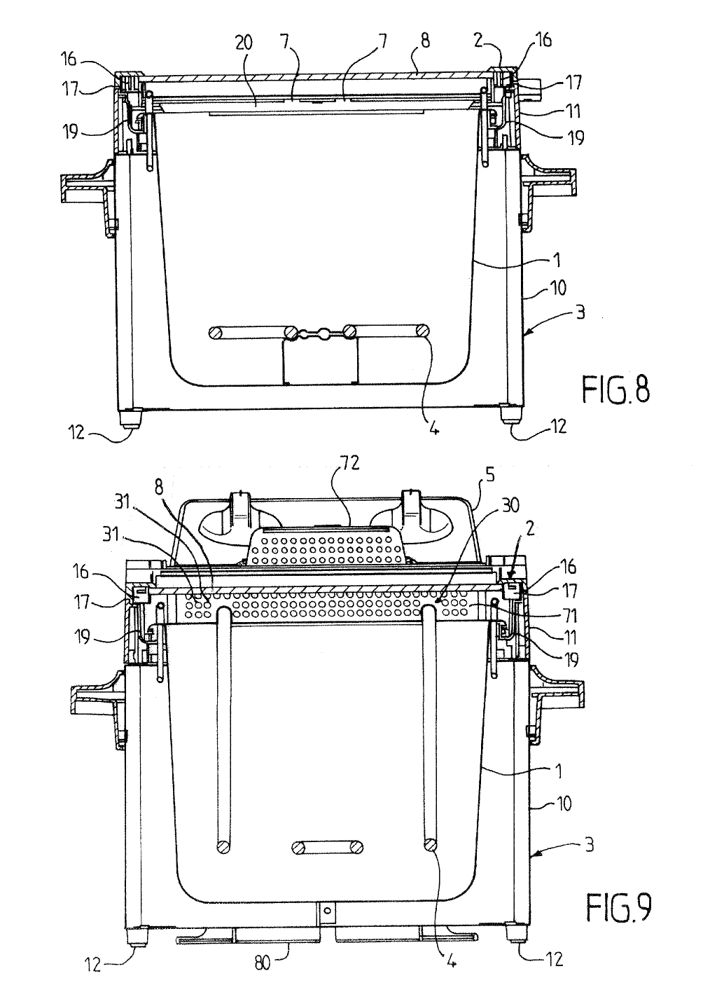

Air inlet 20 extends transversely relative to vat 1 and relative to viewing window 8. As seen in FIG. 8, air inlet 20 extends over at least 80% of the width of viewing window 8 disposed above vat 1 and over at least 80% of the width of vat 1.

Air and cooking vapor outlet 30 extends transversely relative to vat 1 and relative to cooking window 8. As seen in FIG. 9, air and cooking vapor outlet 30 extends over at least 80% of the width of viewing window 8 and and over at least 80% of the width of vat 1.

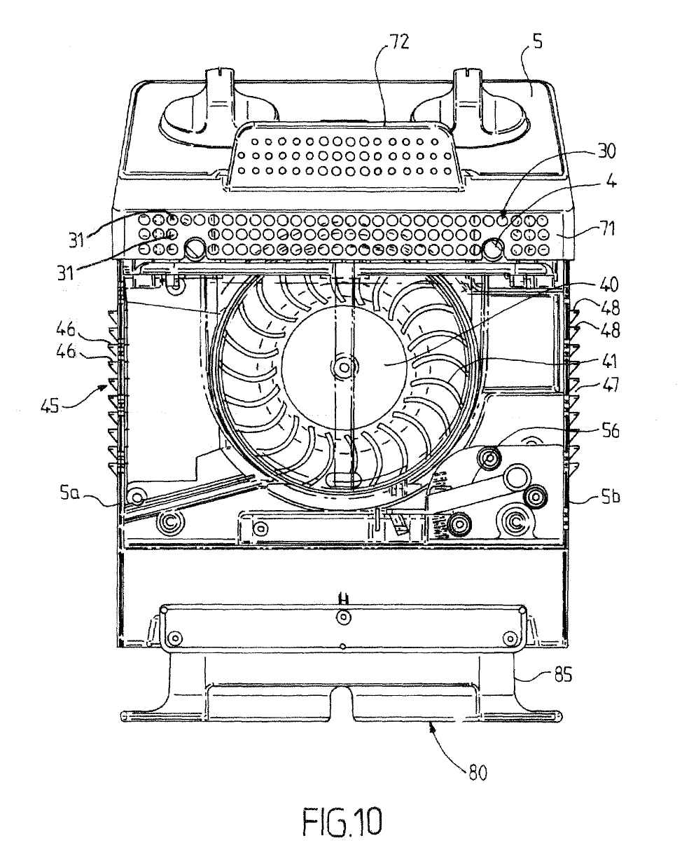

Air and cooking vapor outlet 30 is disposed on a lateral surface of filtering device 40 adjacent to vat 1, and in front of control box 5, as seen in particular in FIG. 10. Air and cooking vapor outlet 30 is disposed above the level of an upper edge of vat 1. Thus, front wall 71 of cartridge holder 53 is disposed above the level of an upper edge of vat 1.

As seen in FIGS. 6, 7, 8 and 9, lid 2 has a lower surface that contributes to channeling air and cooking vapors toward air and cooking vapor outlet 30, in cooperation with lower surfaces 19 (FIGS. 8 and 9) of top part 11 of outer housing 3. More particularly, viewing window 8 is mounted between two lateral elements 16 of lid 2, provided so as to be seated between upper edges 17 of outer housing 3 when lid 2 is closed, as seen in FIGS. 8 and 9. If desired, a gasket 18 can be mounted underneath lid 2 so as to rest on filter unit 51 when the lid is closed, as seen in FIG. 6. Alternatively, an additional air inlet disposed between lid 2 and filter unit 51 or control box 5 advantageously has a cross-section smaller than the cross-section of air inlet 20.

As seen in FIGS. 7, 8 and 9, the distance between air inlet 20 and air and cooking vapor outlet 30 is greater than the width of air inlet 20 and greater than the width of air and cooking vapor outlet 30.

As seen in FIG. 10, suction device 40 has a cooking vapor vent 45 disposed on one side 5a of control box 5. Cooking vapor vent 45 has upward-facing exhaust louvers 46. Suction device 40 has another cooking vapor vent 47 disposed on the opposite side 5b of control box 5, ventilation unit 41 being disposed between sides 5a and 5b of the control box. The other cooking vapor vent 47 also has upward-facing exhaust louvers 48.

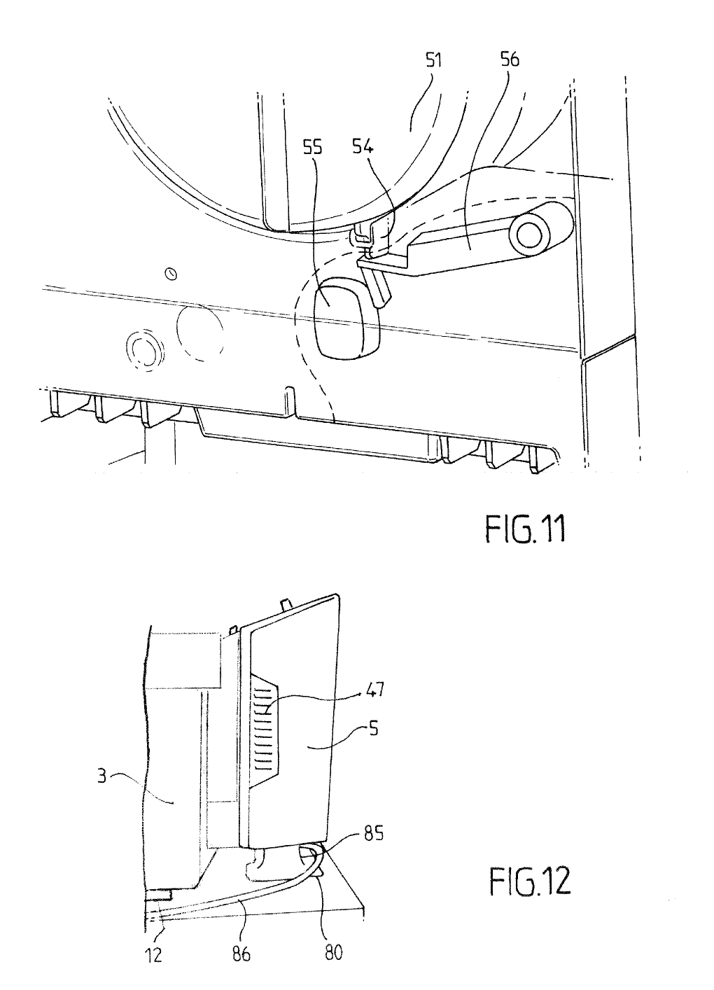

As seen in FIGS. 5 and 11, filter unit 51 includes a presence detecting means 54 provided for actuating a switch 55 that enables the appliance to operate when filter unit 51 is in place inside the appliance and prevents the appliance from operating when filter unit 51 is not in place inside the appliance.

As seen more clearly in FIG. 5, presence detecting means 54 is disposed on cartridge holder 53. More particularly, as seen in FIGS. 10 and 11, presence detecting means 54 actuates switch 55 by means of a pivotably mounted lever 56.

As seen in FIG. 10, control box 5 has a support element 80. As shown in FIG. 12, when control box 5 is mounted on outer housing 3 resting on a work surface, the bottom of support element 80 is at a higher elevation than the bottoms of support elements 12 and is spaced from said work surface.

As seen in FIG. 12, control box 5 has a storage area 85 about which an electrical cord 86 may be coiled for storage. More particularly, support element 80 is disposed underneath area 85 for storage of electrical cord 86. Support element 80 forms a foot.

A suction rate of 36 m³/h for suction device 40 provides satisfactory suction performance for cooking French fries in an oil bath from 1 kg of fresh potatoes. The estimated maximum instantaneous flow of cooking vapors escaping from the oil bath being on the order of 1.7 m³/h, the dilution of the cooking vapors is approximately 1:20. A ratio of 30:1 between the suction rate of suction device 40 expressed in m³/h and the fresh potato capacity of the appliance expressed in kg is considered satisfactory; a ratio of 20:1 is considered acceptable.

An appliance according to the present invention will operate and be used in the following way.

The user places vat 1 into outer housing 3, electric heating resistor 4 into vat 1, and lid 2 onto outer housing 3. The user can program the cooking temperature and cooking time. The user then places foods such as fresh or precooked frozen potatoes into basket 6, preferably with the latter in a raised position above a cooking bath contained in vat 1. Switching on the appliance supplies power to electric heating resistor 4 and suction device 40. The user preferably closes lid 2 onto outer housing 3. Suction device 40 draws in ambient air through air inlet 20. The air introduced through air inlet 20 is directed toward air and cooking vapor outlet 30, passing under viewing window 8. More particularly, air introduced through air inlet 20 is channeled underneath viewing window 8 toward air and cooking vapor outlet 30 through the top part of the cooking chamber disposed above vat 1. The flow of air generated by suction device 40 performs a scavenging of the cooking vapors under viewing window 8 toward air and cooking vapor outlet 30. Preferably, the air introduced into the cooking chamber through air inlet 20 and sucked out through air and cooking vapor outlet 30 scavenges at least 80% of the width of the surface of viewing window 8 disposed above vat 1. This scavenging contributes to evacuating the cooking vapors toward air and cooking vapor outlet 30, lowering the temperature of viewing window 8, preventing the appearance of steam that would block a view of the contents of vat 1, and preventing the formation of condensates capable of dropping back into the cooking bath, particularly when the user has immersed basket 6 into the cooking bath in the lowered position inside vat 1. The air and cooking vapors sucked out by suction device 40 are then filtered by filtering device 50 and discharged from the appliance, after filtration, through cooking vapor vents 45 and 47.

The appliance according to the present invention makes it possible to cook with the lid closed while observing the contents of the cooking chamber, with good visibility, and while preventing condensates from falling back into the vat. In addition, as a result of the flow of fresh air admitted through the air inlet into the cooking chamber, the increase in the temperature of the top surface of lid 2 during cooking can be limited, the cooking vapors are filtered through filter unit 51, and the temperature of the gaseous exhaust exiting the appliance through cooking vapor vent 45 and through the other cooking vapor vent 47 is also limited. The appliance according to the present invention offers improved conditions for use relative to the usual appliances.

As a variant, the electric heating resistor is not necessarily disposed inside the cooking chamber, but can, for example, be disposed underneath vat 1 inside outer housing 3.

As a variant, suction device 40 is not necessarily disposed inside control box 5, but could, for example, be disposed inside outer housing 3.

As a variant, suction device 40 is not necessarily associated with a rectangular vat 1.

As a variant, suction device 40 is not necessarily associated with a filtering device.

As a variant, filtering device 50 does not necessarily include a filter unit 51 that is removable with respect to suction device 40.

As a variant, viewing window 8 is not necessarily rectangular.

As a variant, viewing window 8 is not necessarily formed by a single pane, but could comprise several panes.

The present invention is not in any way limited to the exemplary embodiment described and its variants, but includes many modifications within the scope of the claims.

This application relates to subject matter disclosed in French Application number 08 03748, filed on Jul. 2, 2008, the disclosure of which is incorporated herein by reference.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A cooking appliance, comprising:
a vat and a lid that define and enclose a cooking chamber, said lid having a viewing window disposed at least partly above said vat, said cooking chamber having an air inlet and an air and cooking vapor outlet; and
a suction device in fluid flow communication with said outlet, wherein:
said inlet and outlet are configured and positioned such that air introduced through said inlet is directed toward said outlet while passing under said viewing window, and
said outlet comprises a plurality of perforations forming conduits extending away from said viewing window.

2. Cooking appliance according to claim 1, wherein said inlet is disposed at an opposite side of said window from said outlet.

3. Cooking appliance according to claim 1, wherein said inlet and outlet are arranged such that air introduced through said air inlet is channeled under said viewing window toward said outlet through a top part of said cooking chamber disposed above said vat.

4. Cooking appliance according to claim 1, wherein said viewing window has a lower surface that is inclined upward in a direction from said inlet to said outlet.

5. Cooking appliance according to claim 1, wherein said viewing window is made of glass.

6. Cooking appliance according to claim 1, wherein said inlet and said outlet are spaced from each other in a direction between opposed edges of said vat.

7. Cooking appliance according to claim 1, further comprising an outer housing in which said vat is disposed.

8. Cooking appliance according to claim 7, wherein said vat is removably mounted in said outer housing.

9. Cooking appliance according to claim 7, wherein said air inlet is disposed between said outer housing and said lid.

10. Cooking appliance according to claim 1, wherein said suction device is removable from said vat.

11. Cooking appliance according to claim 10, further comprising a control box supporting said suction device.

12. Cooking appliance according to claim 11, wherein said suction device is housed inside said control box.

13. Cooking appliance according to claim 12, wherein said suction device has a cooking vapor vent disposed laterally relative to said control box.

14. Cooking appliance according to claim 1, further comprising a filtering device with which said suction device is associated.

15. Cooking appliance according to claim 14, wherein said filtering device includes a filter unit that is removable relative to said suction device.

16. Cooking appliance according to claim 1, wherein said cooking appliance is an electric fryer,
